(19) United States
(12) Patent Application Publication
(10) Pub. No.: US 2025/0242840 A1
(43) Pub. Date: Jul. 31, 2025

(54) BRAKE SYSTEM FOR A RAIL VEHICLE

(71) Applicant: DELLNER BUBENZER AB, BORLÄNGE (SE)

(72) Inventor: Viktor PRIM, SANDVIKEN (SE)

(21) Appl. No.: 18/833,544

(22) PCT Filed: Nov. 9, 2022
(86) PCT No.: PCT/EP2022/081200

§ 371 Date: Jul. 26, 2024

(30) Foreign Application Priority Data
Feb. 3, 2022 (EP) 22155085.8

(51) Int. Cl. B61H 5/00; F16D 55/224; F16D 66/00; F16D 121/14; F16D 121/26; F16D 123/00; F16D 127/06; F16D 129/02; F16D 129/04

(52) U.S. Cl. CPC B61H 5/00; F16D 55/2245; F16D 2066/003; F16D 2121/14; F16D 2121/26; F16D 2123/00; F16D 2127/06; F16D 2129/02; F16D 2129/04

(57) ABSTRACT

A rail vehicle (100) has a brake system containing a brake actuator (120) and a brake unit (200). The brake actuator (120) receives a brake command (cmdp) and produces a resulting electric brake-force signal (BF). The brake unit (200) contains first and second pressing members (211) and a rotatable member (110) being mechanically linked to at least one wheel (105) of the rail vehicle (100). When receiving the electric brake-force signal (BF), the brake unit (200) causes the first and second pressing members (211) to apply a braking force to the rotatable member (110). A gear assembly (220) in the brake unit (200) operates mechanically on the first and second pressing members (211). A stepper motor (230), in turn, acts on the gear assembly (120) in response to the electric brake-force signal (BF), thus causing the first and second pressing members (211) to move towards or away from the rotatable member (110) and attain a specified position interrelationship. Based on a position signal (P) indicating an angular position of the stepper motor's (230) power transmission shaft, the brake unit (200) determines if the specified position interrelationship has been attained; and if so, it stops producing the electric brake-force signal (BF) to allow a self-locking mechanism to lock the first and second pressing members (211).

### TECHNICAL FIELD

The present invention relates generally to immobilization of rail vehicles. Especially, the invention relates to a brake system for a rail vehicle according to the preamble of claim 1.

### BACKGROUND

In operation of an electrically powered rail vehicle, the onboard motors are typically engaged as generators to decelerate the rail vehicle. However, for efficiency and safety reasons, one cannot rely solely on this braking strategy. In particular, a brake function will always be needed to ensure emergency braking functionality and that the rail vehicle remains stationary after that it has been brought to a stop.

In many cases, the same brake units are used for different types of braking functionality, such as service braking, emergency braking and parking braking. Today's rail vehicle brakes characteristically use pneumatically regulated brakes. This is disadvantageous inter alia due to their slow and imprecise regulation, however also because the risk of leakages and resulting malfunction.

Recently, electrically controlled brakes have been presented as an alternative to pneumatically regulated brakes. For example, US 2020/0198605 describes a microcomputer-controlled electromechanical braking system containing an electromechanical braking control device and an electromechanical braking unit. The electromechanical braking control device includes a braking microcomputer control unit, an electromechanical control unit and a standby power supply module. The braking microcomputer control unit receives a braking instruction signal sent by a driver or an automatic driving system, performs the calculation of a target braking force and braking management. If the electromagnetic brake is powered off, a screw-and-nut arrangement locks the brake to maintain the braking force. When a torque motor rotor rotates reversely, the nut makes a translational motion reversely, and the braking force is released.

Thus, an electromechanical braking system is known, which has a locking mechanism to maintain the brake force if the power supply to the brake fails. However, since the known design cannot verify that the brake's friction elements are truly kept in the intended braking position, with or without electricity, there is room for improvement of the braking systems reliability.

### SUMMARY

The object of the present invention is therefore to offer a solution that solves the above problem and ensures that a specified braking force always remains applied, for instance also if the electric power supply to the brakes is interrupted.

According to the invention, the object is achieved by a brake system for a rail vehicle, which brake system contains a brake actuator, a brake unit, a gear assembly, a self-locking mechanism, a stepper motor and a position sensor. The brake actuator is configured to receive a brake command, and in response thereto produce an electric brake-force signal. The brake unit includes first and second pressing members and a rotatable member being mechanically linked to at least one wheel of the rail vehicle. The brake unit is configured to receive the electric brake-force signal, and in response thereto cause the first and second pressing members to apply a braking force to the rotatable member. The gear assembly is arranged to operate mechanically on the first and second pressing members. In response to the electric brake-force signal, the stepper motor is configured to act on the gear assembly so as to cause the first and second pressing members to move towards or away from the rotatable member and attain a specified position interrelationship. The self-locking mechanism is configured to automatically lock the first and second pressing members if a supply of electric power to the brake unit fails. The position sensor is configured to produce a position signal indicating an angular position of a power transmission shaft of the stepper motor. The brake unit is further configured to receive the position signal, and based thereon determine whether the specified position interrelationship has been attained. If so, the brake unit is configured to stop producing the electric brake-force signal, thereby allowing the self-locking mechanism to lock the first and second pressing members in the specified position interrelationship.

The above brake system is advantageous because the stepper motor is capable of providing highly accurate positioning of its power transmission shaft. In addition to that, the position sensor provides a confirmation that the specified position interrelationship of the first and second pressing members has actually been attained. In combination with the self-locking functionality, this accomplishes an extremely reliable brake. Moreover, any malfunction of the brake unit can be identified immediately by comparing a position commanded to the stepper motor with the position signal received from the position sensor.

According to one embodiment of the invention, the brake unit also contains a load-cell sensor configured to produce a sensor signal representing the magnitude of a force applied by the first and second pressing members on the rotatable member. Moreover, the brake actuator is configured to receive the sensor signal, and based thereon generate a status message confirming that the brake command has been effected. Consequently, an extra confirmation of a successful braking is offered.

Preferably, the self-locking mechanism is configured to exclusively allow the specified position interrelationship between the first and second pressing members to be altered in response to action by the stepper motor, which action, in turn, is caused by the electric brake-force signal. Thus, for example, an applied parking brake can only be released by a negating parking-brake command.

According to one embodiment of the invention, the gear assembly contains a worm gear arrangement with such a gearing ratio that the specified position interrelationship de facto cannot be altered by reverse movement, i.e. by action on the first and second pressing members. Thus the worm gear arrangement constitutes the self-locking mechanism. This is cost-efficient and provides an overall compact design.

According to another embodiment of the invention, the self-locking mechanism contains a hydraulic lock mechanism, a motor-axle lock mechanism or a toothed-wheel lock mechanism that is arranged on a power transmission shaft of the stepper motor. This allows for alternative types of gear assemblies, e.g. planetary gears, which are generally more efficient than the worm gear arrangement.

Specifically, if the self-locking mechanism contains the hydraulic lock mechanism, this mechanism, in turn, may include a hydraulic cylinder with first and second fluid compartments separated by a wall member that is mechanically linked to an actuator operated via the power transmission shaft of the stepper motor. The hydraulic lock mechanism further includes a bypass conduit interconnecting the first and second fluid compartments and a counterbalanced valve arranged on the bypass conduit. In an open state, the counterbalanced valve is configured to enable hydraulic fluid to pass between the first and second fluid compartments and thus allow the wall member to move along the hydraulic cylinder. In a closed state, the counterbalanced valve is configured to prevent hydraulic fluid to pass between the first and second fluid compartments thus locking the wall member in a particular position with respect to the hydraulic cylinder. Thereby, by closing the counterbalanced valve when the specified position interrelationship has been attained, a secure locking in this position is ensured.

Specifically, if the self-locking mechanism contains the motor-axle lock mechanism, this mechanism, in turn, may include a rotatable plate mechanically linked to the power transmission shaft, and at least one locking pin configured to selectively either lock the rotatable plate against a fix part of the stepper motor, or allow the rotatable plate to rotate freely around a symmetry axis of the power transmission shaft. Thereby, by locking the rotatable plate against the fix part of the stepper motor when the specified position interrelationship has been attained, a secure locking in this position is ensured in an alternative manner and through a very compact design.

Specifically, if the self-locking mechanism contains the toothed-wheel lock mechanism, this mechanism, in turn, may include first and second toothed rings. The first toothed ring is non-rotatable, and the second toothed ring is mechanically linked to the power transmission shaft. At least one of the first and second toothed rings is configured to move along a symmetry axis of the power transmission shaft to selectively either cause a first set of teeth of the first toothed ring to either engage a second set of teeth of the second toothed ring, or not. In the former case, a rotation of the power transmission shaft is prevented, and in the latter case, the power transmission shaft is allowed to rotate freely around its symmetry axis. Thereby, by causing the first and second rings to engage when the specified position interrelationship has been attained, a secure locking in this position is ensured in yet an alternative manner and through another highly compact design.

According to yet another embodiment of the invention, the brake system contains a backup power unit configured to receive electric power from a power line in the rail vehicle during operation of the rail vehicle and accumulate the received electric power. The backup power unit is further configured to provide the accumulated electric power to the brake actuator and the brake unit in case of an outage of the electric power on the power line. Consequently, the brake system can be operated also when the rail vehicle does not receive any input power.

For example, the backup power unit may contain at least one rechargeable battery and a battery charger connected to the power line and configured to transfer electric power received from the power line to the at least one rechargeable battery. The at least one rechargeable battery is configured to feed electric power to the brake actuator and the brake unit if the electric power on the power line fails.

Alternatively, or additionally, the backup power unit may contain at least one capacitive element and a rectifier connected to the power line and configured to transfer electric power received from the power line to the at least one capacitive element. The at least one capacitive element is arranged to feed electric power to the brake actuator and the brake unit if the electric power on the power line fails.

According to still another embodiment of the invention, the brake actuator is connected to at least one data bus in the rail vehicle. The at least one data bus is configured to control signals and/or status messages. For example, the brake actuator may be configured to receive the brake command as a control signal via the data bus. Hence, the brake can be controlled in an overall efficient and reliable manner.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 schematically illustrates a rail vehicle equipped with a brake system according to one embodiment of the invention;

FIG. 2 shows a brake unit according to one embodiment of the invention;

FIG. 3 illustrates how a gear assembly may be implemented according to one embodiment of the invention;

FIGS. 4-6 exemplify different self-locking mechanisms according to embodiments of the invention;

FIG. 7 shows a backup power unit according to a first embodiment of the invention; and

FIG. 8 shows a backup power unit according to a second embodiment of the invention;

### DETAILED DESCRIPTION

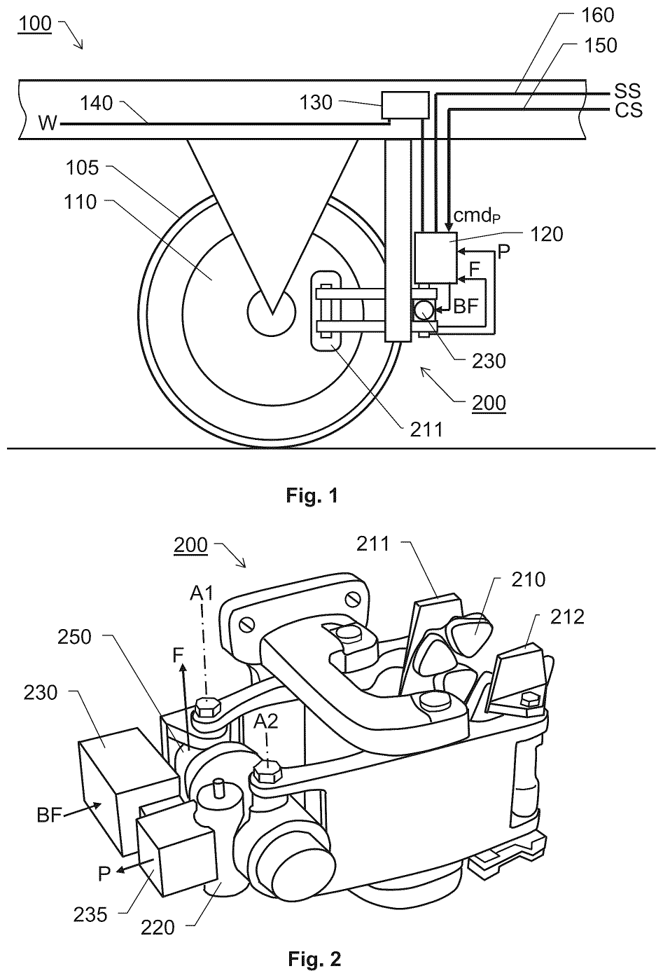

FIG. 1 schematically illustrates a rail vehicle 100 equipped with a brake system according to one embodiment of the invention. In FIG. 2; we see a brake unit 200 according to one embodiment of the invention.

The proposed brake system contains a brake actuator 120, a brake unit 200, a gear assembly 220, a stepper motor 230, a position sensor 235 and a self-locking mechanism.

The brake actuator 120 is configured to receive a brake command cmdp, for example in the form of a control signal CS over a data bus 150 in the rail vehicle 100.

In response to the brake command cmdp, the brake actuator 120 is configured to produce an electric brake-force signal BF. The brake command cmdp may, at least indirectly, specify a brake force to be applied.

The brake unit 200 includes first and second pressing members 211 and 212 respectively and a rotatable member 110 that is mechanically linked to at least one wheel 105 of the rail vehicle 100. The brake unit 200 is configured to receive the electric brake-force signal BF. In response to the electric brake-force signal BF, the brake unit 200 is configured to perform a braking operation. Typically, the brake command cmdp is configured to cause the first and second pressing members 211 and 212 to apply a braking force to the rotatable member 110 so as to reduce a rotation speed of the at least one wheel 105. In a parking-brake situation, the brake command cmdp is configured to cause the at least one wheel 105 to remain immobile. When the rail vehicle shall resume its movement, a negating parking-brake command cmdp is produced which is configured cause the first and second pressing members 211 and 212 to release an already applied braking force to the rotatable member 110 so as to enable the rotatable member 110 and the at least one wheel 105 to rotate again.

The gear assembly 220 is arranged to operate mechanically on the first and second pressing members 211 and 212 respectively. Functionally, the gear assembly 220 is located between the stepper motor 230 and the pressing members 211 and 212.

In response to the electric brake-force signal BF, the stepper motor 230 is configured to act on the gear assembly 220 so as to cause the first and second pressing members 211 and 212 to move towards or away from the rotatable member 110 and attain a specified position interrelationship. Here, a first specified position interrelationship may correspond to a released state for the brake, i.e, wherein the rotatable member 110 and the at least one wheel 105 are enabled to rotate; and a second specified position interrelationship may correspond to a braked state, wherein the first and second pressing members 211 and 212 apply a braking force to the rotatable member 110 so as to keep the at least one wheel 105 immobile. Naturally, according to the invention, any number of intermediate states between the first and second states are conceivable, which intermediate states correspond to various magnitudes of braking force being applied to the at least one wheel 105.

The stepper motor 230 is advantageous because it provides highly accurate positioning of its power transmission shaft without requiring a position sensor for feedback. The stepper motor 230 is typically a brushless DC electric motor that divides a full rotation into a number of equal steps, say 100, which may be provided by a gear-shaped iron rotor with 25 teeth giving 3.6 degrees of rotation per step. The stepper motor 230 can be commanded to move and hold a position at one of these steps by open loop control provided that the motor is adapted to the application in respect to torque and speed.

However, due to various mechanical disturbances, e.g. caused by snow, ice, dirt and/or grit, the position to which the power transmission shaft is commanded may not always be achieved. Additionally, or alternatively, various components of the brake unit 200 may fail, e.g. pieces of brake linings 210 may fall off and/or bushings may be broken. Therefore, according to the invention, a position sensor 235 is configured to produce a position signal P that indicates an angular position of the power transmission shaft. The position sensor 235 may for example be arranged on the power transmission shaft of the stepper motor 230. The position signal P may here be represented by a number of electric or optic pulses, where the number of pulses is proportional to a rotational angle of the power transmission shaft.

The brake unit 200 is configured to receive the position signal P. Based thereon, the brake unit 200 is configured to determine whether the specified position interrelationship has been attained.

If the brake unit 200 determines that the specified position interrelationship has been attained, the brake unit 200 is configured to stop producing the electric brake-force signal BF, which allows the self-locking mechanism to lock the first and second pressing members 211 and 212 in the specified position interrelationship.

If, however, the brake unit 200 determines that the specified position interrelationship has not been attained, the brake unit 200 is configured to continue producing the electric brake-force signal BF until the specified position interrelationship has been attained.

According to one embodiment of the invention, the brake unit 200 further contains a load-cell sensor 250 configured to produce a sensor signal F representing the magnitude of a force applied by the first and second pressing members 211 and 212 on the rotatable member 110. The load-cell sensor 250 may be a ring-torsion type of sensor arranged on a first axis A1 included in a mechanical link between the gear assembly 220 and the first pressing member 211. Additionally, or alternatively, the load-cell sensor 250 may be arranged on a second axis A2 included in a mechanical link between the gear assembly 220 and the second pressing member 212.

Additionally, or alternatively, one or more load-cell sensors, e.g. of bending, shear, compression and/or tension type, may be arranged on the first and second pressing members 211 and 212.

In any case, the brake actuator 120 is configured to receive the sensor signal F, and based thereon generate a status message SS confirming that the brake command cmdp has been effected.

The self-locking mechanism, which will be discussed in detail below with reference to FIGS. 2 to 6, is configured to lock the first and second pressing members 211 and 212 in the specified position interrelationship when the specified position interrelationship has been attained and maintain this condition irrespective of whether or not electric power W is supplied to the brake unit 200.

Preferably, for safety reasons, the self-locking mechanism is configured to exclusively allow the specified position interrelationship between the first and second pressing members 211 and 212 to be altered in response to action by the stepper motor 230, which action, in turn, is caused by the electric brake-force signal BF. In practice, this means that the only way to release a parking brake once it has been applied is to generate a negating brake command cmdp to the brake actuator 120. The negating parking-brake command cmdp causes the brake actuator 120 to produce such an electric brake-force signal BF that the specified position interrelationship between the first and second pressing members 211 and 212 is altered to the state in which the rotatable member 110 and the at least one wheel 105 are freed to rotate.

As mentioned above, the brake command cmdp may be sent as a control signal CS over a data bus 150 in the rail vehicle 100. According to one embodiment of the invention, the rail vehicle 100 contains at least one first data bus 150 configured to communicate control signal CS. Preferably, the rail vehicle 100 also contains at least one second data bus 160 configured to communicate status messages SS, for example reflecting a current state of the brake, and/or the position interrelationship between the first and second pressing members 211 and 212.

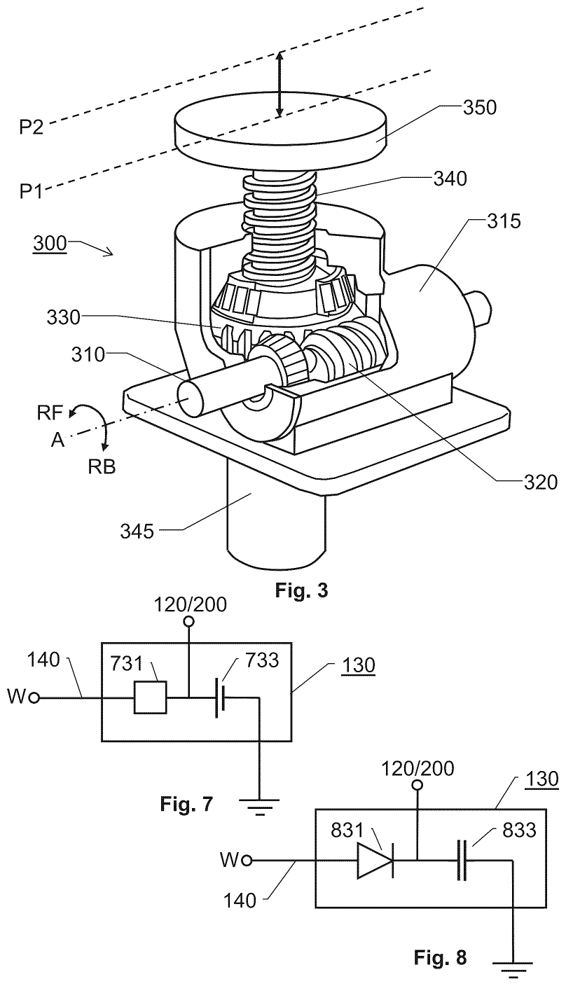

FIG. 3 shows an example of the gear assembly 220 according to one embodiment of the invention, where the gear assembly 220 is implemented by a worm gear arrangement 300.

Here, mechanical power enters via a power transmission shaft 310 of the stepper motor 230. The stepper motor 230 is configured to rotate the power transmission shaft 310 in a forward direction RF or a backward direction RB. As a result, a load pad 350 is fed outward or inward, for example between first and second positions P1 and P2 respectively by action of an input worm 320 on a worm gear 330 acting on a lifting screw 340. Preferably, the worm gear arrangement 300 further includes first and second protection tubes 315 and 345 covering the input worm 320 and the lifting screw 340 respectively.

According to this embodiment of the invention, the worm gear arrangement 300 has such a gearing ratio that movement in the opposite direction is de facto impossible, i.e. pushing/pulling the load pad 350 to cause the power transmission shaft 310 to rotate in the forward or backward directions RF/RB. Consequently, the specified position interrelationship between the first and second pressing members 211 and 212 cannot be altered by movement of the first and second pressing members 211 and 212. In other words, in this embodiment, the worm gear arrangement 300 also constitutes the self-locking mechanism.

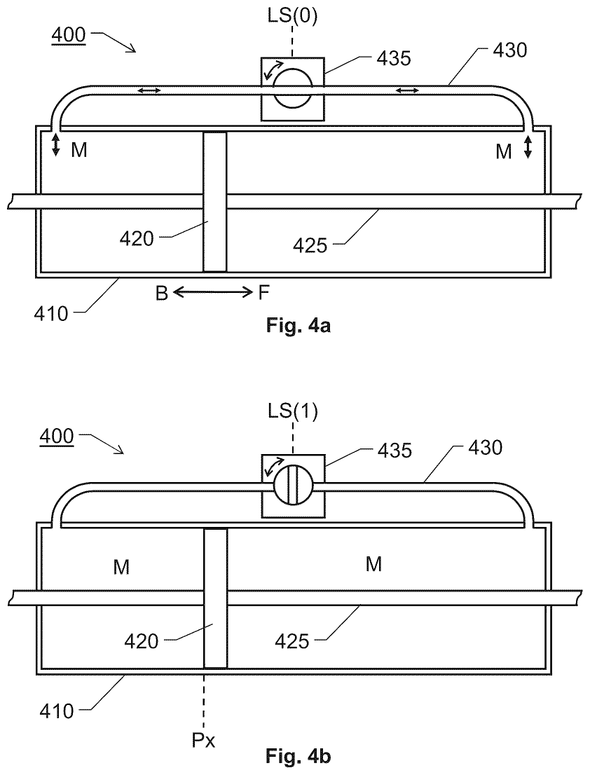

FIGS. 4a and 4b illustrate a second embodiment according to the invention, wherein the self-locking mechanism contains a hydraulic lock mechanism 400 arranged on an actuator 425 operated via the power transmission shaft 310 of the stepper motor 230. For example, in FIG. 4, the actuator 425 corresponds to the lifting screw 340 in FIG. 3.

The hydraulic lock mechanism 400 includes a hydraulic cylinder 410, a bypass conduit 430 and a counterbalanced valve 435.

The hydraulic cylinder 410 contains a wall member 420 that separates an interior of the hydraulic cylinder 410 into first and second fluid compartments, which are both filled with hydraulic fluid M. The wall member 420 is mechanically linked to the actuator 425 being operated directly or indirectly via the power transmission shaft 310.

The bypass conduit 430 interconnects the first and second fluid compartments outside of the hydraulic cylinder 410.

The counterbalanced valve 435 is arranged on the bypass conduit 430. In an open state LS(0), the counterbalanced valve 435 is configured to enable the hydraulic fluid M to pass between the first and second fluid compartments. Thus, the wall member 420 is allowed to move back B and forth F along the hydraulic cylinder 410, thereby enabling the actuator 425 to follow these movements. In a closed state LS (1), the counterbalanced valve 435 is configured to prevent the hydraulic fluid M to pass between the first and second fluid compartments. As a result, the wall member 420 is locked in a particular position Px with respect to the hydraulic cylinder 410, and the actuator 425 likewise becomes immobilized. When the specified position interrelationship has been attained, the counterbalanced valve 435 is controlled to the closed state LS(1), and the first and second pressing members 211 and 212 are locked in this position.

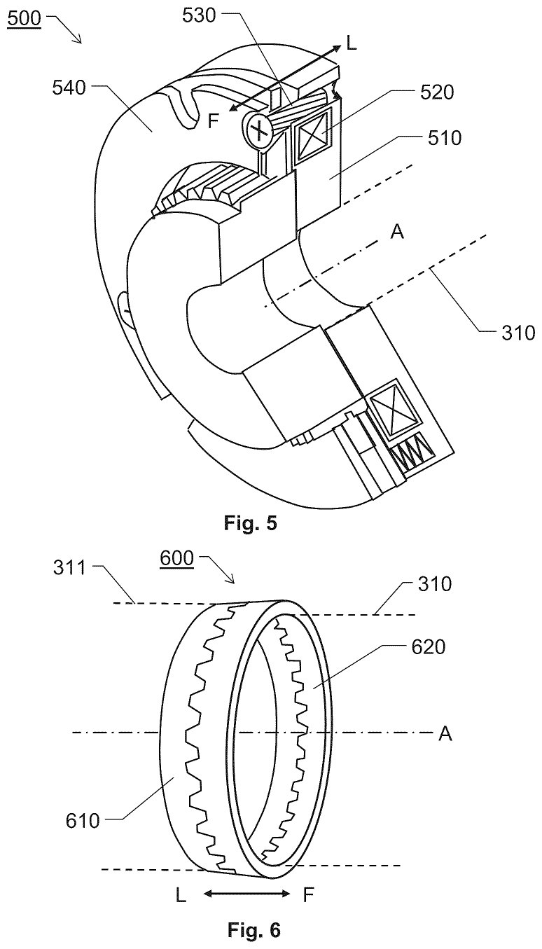

FIG. 5 illustrates a third embodiment according to the invention, wherein the self-locking mechanism contains a motor-axle lock mechanism 500 arranged on the power transmission shaft 310 of the stepper motor 230. The motor-axle lock mechanism 500 includes a rotatable plate 540 and at least one locking pin 530.

The rotatable plate 540 is mechanically linked to the power transmission shaft 310.

The at least one locking pin 530 is configured to selectively either lock the rotatable plate 540, or allow the same to rotate freely around a symmetry axis A of the power transmission shaft 310.

The stepper motor 230 contains at least one cavity, e.g. in a yoke 510 of the stepper motor 230, which at least one cavity in a locked state L is configured to receive the at least one locking pin 530 and thereby hold the rotatable plate 540 and the power transmission shaft 310 stationary. In a unlocked state F, the at least one locking pin 530 is pulled out from the at least one cavity. As a result, the rotatable plate 540 and the power transmission shaft 310 are allowed to rotate freely around a symmetry axis A of the power transmission shaft 310. When the specified position interrelationship has been attained, the at least one locking pin 530 is controlled to the locked state L, and the first and second pressing members 211 and 212 are locked in this position.

FIG. 6 illustrates a fourth embodiment of the invention, wherein the self-locking mechanism contains a toothed-wheel lock mechanism 600 arranged on the power transmission shaft 310 of the stepper motor 230.

The toothed-wheel lock mechanism 600 includes first and second toothed rings 610 and 620 respectively. The first toothed ring 610 non-rotatable, for example by being fixed to a stationary part of the stepper motor 230. The second toothed ring 620 is mechanically linked to the power transmission shaft 310 to be rotatable together with the power transmission shaft 310 around the symmetry axis A thereof. At least one of the first and second toothed rings 610 and/or 620 is configured to move along the symmetry axis A of the power transmission shaft 310 to selectively either cause a first set of teeth of the first toothed ring 610 to engage a second set of teeth of the second toothed ring 620, or disengage from the second set of teeth.

Said engagement represents a locked state L, wherein a rotation of the power transmission shaft 310 is prevented; and said disengagement represents an unlocked state F, wherein the power transmission shaft 310 is allowed to rotate freely around the symmetry axis A. When the specified position interrelationship has been attained, the first and second toothed rings 610 and 620 are controlled to the locked state L, and the first and second pressing members 211 and 212 are locked in this position.

FIGS. 7 and 8 show a backup power unit 130 according to embodiments of the invention. The backup power unit 130 is configured to receive electric power W from a power line 140 in the rail vehicle 100 during operation of the rail vehicle 100. Typically, electric power W is fed into the rail vehicle 100 via an external overhead line and an onboard current collector. The backup power unit 130 is configured to accumulate the received electric power W and feed at least a portion of the accumulated electric power to the brake actuator 120 and the brake unit 200 in case of an outage in the electric power W on the power line 140.

In the embodiment shown in FIG. 7, the backup power unit 130 is connected between the power line 140 and the brake actuator 120/brake unit 200. The backup power unit 130 contains a battery charger 731 and a rechargeable battery 733.

During normal operation of the rail vehicle 100, electric power W received from the power line 140 passes through the backup power unit 130. At the same time, the battery charger 731 receives the incoming electric power W and charges the battery 733. In case of electric power outage on the power line 140, accumulated electric power from the battery 733 will instead be fed out to the brake actuator 120 and the brake unit 200. Thus, regardless of whether there is electric power W on the power line 140, there will always be electric power available to the brake actuator 120 and the brake unit 200.

FIG. 8 shows a backup power unit 130 according to a second embodiment of the invention, where the backup power unit 130 contains at least one capacitive element 833, such as one or more capacitors, which preferably have relatively high capacity. The backup power unit 130 also includes at least one rectifying element 831. In FIG. 8, this is symbolized by a diode 831. If the power line 140 and is configured to transfer electric power W in the form of direct current, a single diode is typically sufficient to prevent electric charges from being unintentionally discharged from the at least one capacitive element 833, for example in case of a cable break outside of the backup power unit 130.

If, the electric power W received from the power line 140 is of alternating-current type, it is typically advantageous if the backup power unit 130 includes rectifying elements in the form of a diode bridge containing four diodes connected to the power line 140 and which diode bridge is configured to convert the incoming alternating-current power to direct-current power to the at least one capacitive element 833.

In any case, regardless of the type of electric power W received from the power line 140; analogous to the above, if the reception of the electric power W in the brake actuator 120 is interrupted, the at least one capacitive element 833 is arranged to feed electric power to the control circuitry in the brake actuator 120 and the electric motor 230.”

Variations to the disclosed embodiments can be understood and effected by those skilled in the art in practicing the claimed invention, from a study of the drawings, the disclosure, and the appended claims.

The term “comprises/comprising” when used in this specification is taken to specify the presence of stated features, integers, steps or components. The term does not preclude the presence or addition of one or more additional elements, features, integers, steps or components or groups thereof. The indefinite article “a” or “an” does not exclude a plurality. In the claims, the word “or” is not to be interpreted as an exclusive or (sometimes referred to as “XOR”). On the contrary, expressions such as “A or B” covers all the cases “A and not B”, “B and not A” and “A and B”, unless otherwise indicated. The mere fact that certain measures are recited in mutually different dependent claims does not indicate that a combination of these measures cannot be used to advantage. Any reference signs in the claims should not be construed as limiting the scope.

It is also to be noted that features from the various embodiments described herein may freely be combined, unless it is explicitly stated that such a combination would be unsuitable.

The invention is not restricted to the described embodiments in the figures, but may be varied freely within the scope of the claims.

1. A brake system for a rail vehicle (100), which brake system comprises:
a brake actuator (120) configured to receive a brake command (cmdP), and in response thereto produce an electric brake-force signal (BF), and
a brake unit (200) comprising first and second pressing members (211, 212) and a rotatable member (110) being mechanically linked to at least one wheel (105) of the rail vehicle (100), which brake unit (200) is configured to receive the electric brake-force signal (BF), and in response thereto cause the first and second pressing members (211, 212) to apply a braking force to the rotatable member (110),
a gear assembly (220) arranged to operate mechanically on the first and second pressing members (211; 212), and
a self-locking mechanism (300, 400, 500, 600) configured to lock the first and second pressing members (211; 212) if a supply of electric power (W) to the brake unit (200) fails,
wherein the brake unit (200) comprises:
a stepper motor (230) configured to act on the gear assembly (220) in response to the electric brake-force signal (BF), so as to cause the first and second pressing members (211; 212) to move towards or away from the rotatable member (110) and attain a specified position interrelationship, and
a position sensor (235) configured to produce a position signal (P) indicating an angular position of a power transmission shaft of the stepper motor (230), and
the brake unit (200) is configured to receive the position signal (P), and based thereon determine whether the specified position interrelationship has been attained, and if so, stop producing the electric brake-force signal (BF) allowing the self-locking mechanism (300, 400, 500, 600) to lock the first and second pressing members (211; 212) in the specified position interrelationship.

2. The brake system according to claim 1, wherein:
the brake unit (200) further comprises a load-cell sensor (250) configured to produce a sensor signal (F) representing the magnitude of a force applied by the first and second pressing members (211, 212) on the rotatable member (110), and
the brake actuator (120) is configured to receive the sensor signal (F), and based thereon generate a status message (SS) confirming that the brake command (cmdP) has been effected.

3. The brake system according to claim 1, wherein the self-locking mechanism (300, 400, 500, 600) is configured to exclusively allow the specified position interrelationship between the first and second pressing members (211; 212) to be altered in response to action by stepper motor (230), which action is caused by the electric brake-force signal (BF).

4. The brake system according to claim 3, wherein the gear assembly (220) comprises a worm gear arrangement (300) with a gearing ratio configured to de facto prevent the specified position interrelationship to be altered by movement of the first and second pressing members (211; 212), the self-locking mechanism thus being constituted by the worm gear arrangement (300).

5. The brake system according to claim 3, wherein the self-locking mechanism comprises one of:
a hydraulic lock mechanism (400),
a motor-axle lock mechanism (500), and
a toothed-wheel lock mechanism (600)
arranged on the power transmission shaft (310) of the stepper motor (230).

6. The brake system according to claim 5, wherein the self-locking mechanism comprises the hydraulic lock mechanism (400), which, in turn, further comprises:
a hydraulic cylinder (410) with first and second fluid compartments separated by a wall member (420) being mechanically linked to an actuator (425) operated via the power transmission shaft (310),
a bypass conduit (430) interconnecting the first and second fluid compartments, and
a counterbalanced valve (435) arranged on the bypass conduit 430, which counterbalanced valve (435) is configured to, in an open state LS(0), enable hydraulic fluid (M) to pass between the first and second fluid compartments thus allowing the wall member (420) to move (B/F) along the hydraulic cylinder (410), and in a closed state (LS(1)), prevent hydraulic fluid (M) to pass between the first and second fluid compartments thus locking the wall member (420) in a particular position (Px) with respect to the hydraulic cylinder (410).

7. The brake system according to claim 5, wherein the self-locking mechanism comprises the motor-axle lock mechanism (500), which, in turn, further comprises:
a rotatable plate (540) mechanically linked to the power transmission shaft (310), and
at least one locking pin (530) configured to selectively either lock the rotatable plate (540) against a fix part (510) of the stepper motor (230), or allow the rotatable plate (540) to rotate freely around a symmetry axis (A) of the power transmission shaft (310).

8. The brake system according to claim 5, wherein the self-locking mechanism comprises the toothed-wheel lock mechanism (600), which, in turn, further comprises:
a first toothed ring (610) being non-rotatable, and
a second toothed ring (620) being mechanically linked to the power transmission shaft (310), and
at least one of the first and second toothed rings (610, 620) is configured to move along a symmetry axis (A) of the power transmission shaft (310) to selectively either cause a first set of teeth of the first toothed ring (610) to engage a second set of teeth of the second toothed ring (620), thus preventing a rotation of the power transmission shaft (310), or disengaging the first and second sets of teeth, thus allowing the power transmission shaft (310) to rotate freely around the symmetry axis (A).

9. The brake system according to claim 1, further comprising a backup power unit (130) configured to:
receive electric power (W) from a power line (140) in the rail vehicle (100) during operation of the rail vehicle (100);
accumulate the received electric power (W); and
provide the accumulated electric power to the brake actuator (120) and the brake unit (200) in case of an outage of the electric power (W) on the power line (140).

10. The brake system according to claim 9, wherein the backup power unit (130) comprises:
at least one rechargeable battery (733), and
a battery charger (731) connected to the power line (140) and configured to transfer electric power (W) received from the power line (140) to the at least one rechargeable battery (733), and
the at least one rechargeable battery (733) is arranged to feed electric power to the brake actuator (120) and the brake unit (200) if the electric power (W) on the power line (140) fails.

11. The brake system according to claim 9, wherein the backup power unit (130) comprises:
at least one capacitive element (833), and
a rectifier (831) connected to the power line (140) and configured to transfer electric power (W) received from the power line (140) to the at least one capacitive element (833), and
the at least one capacitive element (833) is arranged to feed electric power to the brake actuator (120) and the brake unit (200) if the electric power (W) on the power line (140) fails.

12. The brake system according to claim 1, wherein the brake actuator (120) is connected to at least one data bus (150, 160) in the rail vehicle (100), which at least one data bus (150, 160) is configured to communicate at least one of control signals (CS) and status messages (SS).

13. The brake system according to claim 12, wherein the brake actuator (120) is configured to receive the brake command (cmdP) as one of the at least one control signal (CS) via one of the at least one data bus (150).

14. The brake system according to claim 2, wherein the self-locking mechanism (300, 400, 500, 600) is configured to exclusively allow the specified position interrelationship between the first and second pressing members (211; 212) to be altered in response to action by stepper motor (230), which action is caused by the electric brake-force signal (BF).

15. The brake system according to claim 14, wherein the gear assembly (220) comprises a worm gear arrangement (300) with a gearing ratio configured to de facto prevent the specified position interrelationship to be altered by movement of the first and second pressing members (211; 212), the self-locking mechanism thus being constituted by the worm gear arrangement (300).

16. The brake system according to claim 14, wherein the self-locking mechanism comprises one of:
a hydraulic lock mechanism (400),
a motor-axle lock mechanism (500), and
a toothed-wheel lock mechanism (600) arranged on the power transmission shaft (310) of the stepper motor (230).

17. The brake system according to claim 16, wherein the self-locking mechanism comprises the hydraulic lock mechanism (400), which, in turn, further comprises:
a hydraulic cylinder (410) with first and second fluid compartments separated by a wall member (420) being mechanically linked to an actuator (425) operated via the power transmission shaft (310),
a bypass conduit (430) interconnecting the first and second fluid compartments, and
a counterbalanced valve (435) arranged on the bypass conduit 430, which counterbalanced valve (435) is configured to, in an open state LS(0), enable hydraulic fluid (M) to pass between the first and second fluid compartments thus allowing the wall member (420) to move (B/F) along the hydraulic cylinder (410), and in a closed state (LS (1)), prevent hydraulic fluid (M) to pass between the first and second fluid compartments thus locking the wall member (420) in a particular position (Px) with respect to the hydraulic cylinder (410).

18. The brake system according to claim 16, wherein the self-locking mechanism comprises the motor-axle lock mechanism (500), which, in turn, further comprises:
a rotatable plate (540) mechanically linked to the power transmission shaft (310), and
at least one locking pin (530) configured to selectively either lock the rotatable plate (540) against a fix part (510) of the stepper motor (230), or allow the rotatable plate (540) to rotate freely around a symmetry axis (A) of the power transmission shaft (310).

19. The brake system according to claim 16, wherein the self-locking mechanism comprises the toothed-wheel lock mechanism (600), which, in turn, further comprises:
a first toothed ring (610) being non-rotatable, and
a second toothed ring (620) being mechanically linked to the power transmission shaft (310), and
at least one of the first and second toothed rings (610, 620) is configured to move along a symmetry axis (A) of the power transmission shaft (310) to selectively either cause a first set of teeth of the first toothed ring (610) to engage a second set of teeth of the second toothed ring (620), thus preventing a rotation of the power transmission shaft (310), or disengaging the first and second sets of teeth, thus allowing the power transmission shaft (310) to rotate freely around the symmetry axis (A).

20. The brake system according to claim 19, further comprising a backup power unit (130) configured to:
receive electric power (W) from a power line (140) in the rail vehicle (100) during operation of the rail vehicle (100);
accumulate the received electric power (W); and
provide the accumulated electric power to the brake actuator (120) and the brake unit (200) in case of an outage of the electric power (W) on the power line (140).
